(19) United States
(12) Patent Application Publication
(10) Pub. No.: US 2017/0175312 A1
(43) Pub. Date: Jun. 22, 2017

(54) MEMBER, MEMBER MANUFACTURING METHOD, ELECTRONIC DEVICE, AND ELECTRONIC DEVICE MANUFACTURING METHOD

(71) Applicant: FUJITSU LIMITED, Kawasaki-shi (JP)

(72) Inventors: Koji Omote, Isehara (JP); KOICHI KIMURA, Atsugi (JP)

(73) Assignee: FUJITSU LIMITED, Kawasaki-shi (JP)

(21) Appl. No.: 15/448,893

(22) Filed: Mar. 3, 2017

Related U.S. Application Data
(63) Continuation of application No. PCT/JP2014/076448, filed on Oct. 2, 2014.

(51) Int. Cl. D04B 21/00; H01Q 1/27; H01Q 1/40; H01Q 1/38; D04B 1/14; A41D 1/00

(52) U.S. Cl. CPC D04B 21/00; D04B 1/14; A41D 1/00; H01Q 1/40; H01Q 1/38; H01Q 1/273

(57) ABSTRACT

A member including a fiber part, which is a knitted article, and wiring intertwined into the fiber part.

### CROSS-REFERENCE TO RELATED APPLICATION

This application is a continuation application of International Application No. PCT/JP2014/076448, filed on Oct. 2, 2014, the disclosure of which is incorporated herein by reference in its entirety.

### FIELD

Technology disclosed herein relates to a member, a member manufacturing method, an electronic device, and an electronic device manufacturing method.

### BACKGROUND

Fiber reinforced plastic is sometimes employed in casing for electronic devices. When the fiber reinforced plastic used is impermeable to radio-waves, such as carbon fiber reinforced plastic, it is possible that antenna sensitivity could drop in electronic devices with a built-in antenna. In order to secure antenna sensitivity, technology has been proposed in which a non-electrically conductive resin region, such as one of glass fiber reinforced plastic, is provided at a portion of the case corresponding to the antenna (see, for example, Patent Document 1).

### RELATED PATENT DOCUMENTS

Japanese Laid-Open Patent Application No. 2009-169506

Japanese Laid-Open Patent Application No. 2001-344580

Japanese Laid-Open Patent Application No. H11-45318

Japanese Laid-Open Patent Application No. 2009-23163

### SUMMARY

According to an aspect of the embodiments, a member includes a fiber part, which is a knitted article, and a wiring intertwined into the fiber part.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an exploded perspective view of an electronic device according to a first exemplary embodiment.

FIG. 2 is a perspective view as viewed from an outer side of a lower cover.

FIG. 3 is a perspective view as viewed from an inner side of a lower cover.

FIG. 4 is a drawing in two planes (plan view and cross-section) of a portion around an antenna.

FIG. 5 is an enlarged view of an antenna and a fiber part.

FIG. 6 is a drawing to explain a manufacturing method of a lower cover.

FIG. 7 is an enlarged cross-section of a lower cover according to a second exemplary embodiment.

FIG. 8 is a drawing illustrating a first layer forming a fiber part.

FIG. 9 is a drawing illustrating a second layer forming a fiber part.

FIG. 10 is a drawing to explain a manufacturing method of a lower cover.

FIG. 11 is an enlarged drawing of an antenna and a fiber part according to a third exemplary embodiment.

FIG. 12 is a drawing illustrating how a prepreg including a fiber part is press molded in a die.

FIG. 13 is a drawing illustrating states of a fiber part before and after press molding.

FIG. 14 is a front view illustrating an electronic device according to a fourth exemplary embodiment.

FIG. 15 is an enlarged view illustrating a wearable member.

FIG. 16 is a drawing illustrating a modified example of a wearable member.

FIG. 17 is a plan view illustrating a lower cover according to a fifth exemplary embodiment.

FIG. 18 is a plan view of a fiber part.

FIG. 19 is an enlarged view of an opening-formed region.

FIG. 20 is a drawing to explain a manufacturing method of a lower cover.

FIG. 21 is a drawing to explain a manufacturing method of a lower cover.

FIG. 22 is a drawing to explain a manufacturing method of a lower cover.

FIG. 23 is a drawing to explain a modified example of a lower cover.

FIG. 24 is a drawing illustrating a modified example of a manufacturing method of a lower cover.

FIG. 25 is a drawing illustrating a modified example of a fiber part.

FIG. 26 is a front view illustrating an electronic device according to a sixth exemplary embodiment.

FIG. 27 is an enlarged view of a wearable member.

### DESCRIPTION OF EMBODIMENTS

### First Exemplary Embodiment

First, explanation follows regarding a first exemplary embodiment of technology disclosed herein.

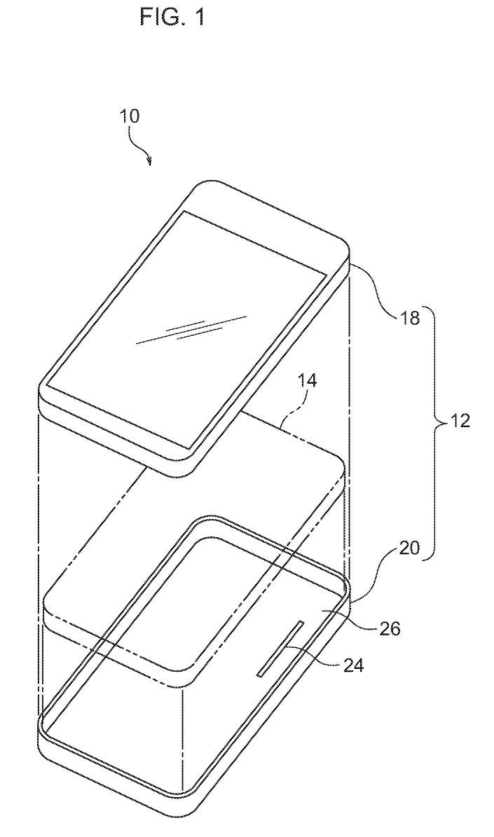

An electronic device 10 according to the first exemplary embodiment, illustrated in FIG. 1, is, for example, a mobile device such as a smartphone or tablet, and includes a case 12 and a unit 14. The unit 14 includes a control circuit, a battery, and the like, and is housed inside the case 12. The case 12 includes an upper cover 18 and a lower cover 20, divided in a thickness direction of the case 12. The lower cover 20 is an example of a “member”.

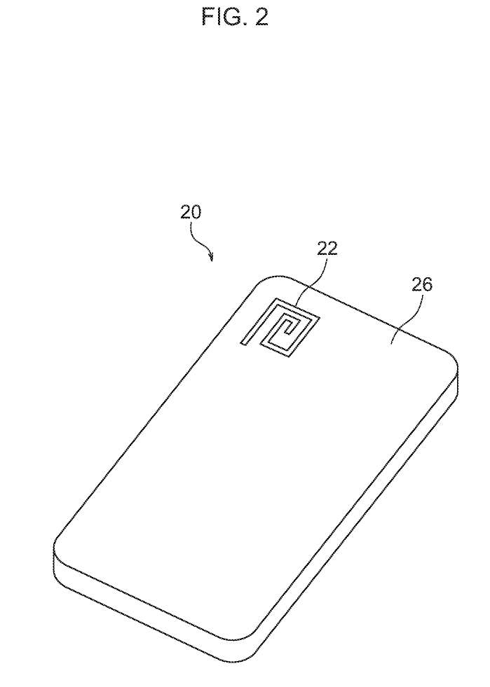

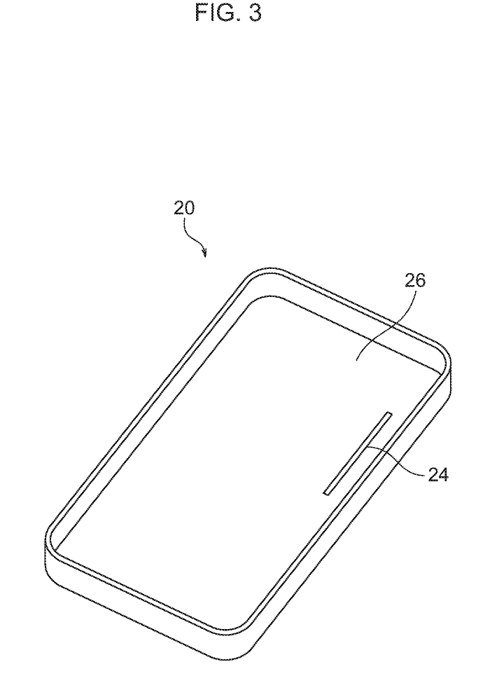

As illustrated in FIG. 2 and FIG. 3, the lower cover 20 includes an antenna 22 and a lead-in wire 24. The antenna 22 is an example of “wiring”. The antenna 22 and the lead-in wire 24 are integrally formed from a single electrically conductive wire. The lead-in wire 24 is electrically connected to the control circuit of the unit 14, illustrated in FIG. 1, and signals received by the antenna 22 are input to the control circuit through the lead-in wire 24. The antenna 22 and the lead-in wire 24 are integrally formed to a main body 26 of the lower cover 20, as described in detail below.

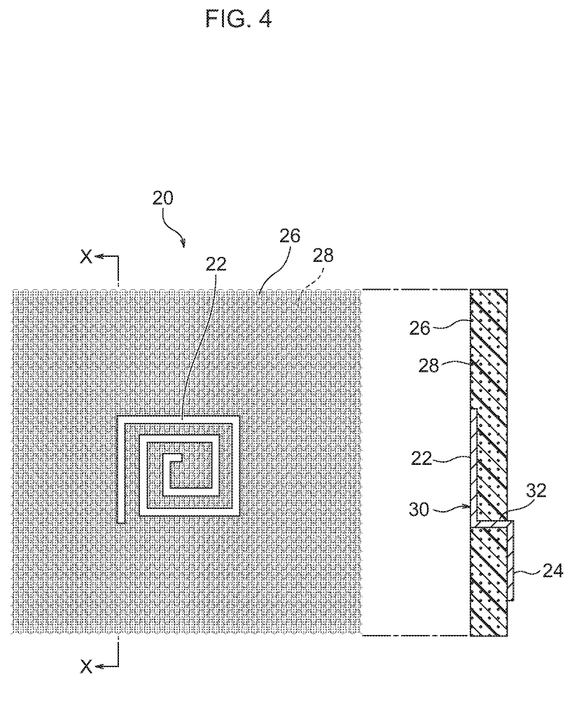

The main body 26 of the lower cover 20 is formed from a fiber reinforced plastic. FIG. 4 includes a plan view of a portion around the antenna 22, and a cross-section (cross-section taken along line X-X) of a portion around the antenna 22. As illustrated in the plan view (on the left) of FIG. 4, the main body 26 of the lower cover 20 formed from a fiber reinforced plastic includes a fiber part 28.

As illustrated in the cross-section (on the right) of FIG. 4, the antenna 22 is formed on an outer side of the main body 26 containing the fiber part 28, and runs along the outer face of the main body 26. The lead-in wire 24, on the other hand, is formed on an inner side of the main body 26, and runs along the inner face of the main body 26. A single electrically conductive wire 30 forming the antenna 22 and the lead-in wire 24 is formed with a connection portion 32 that connects the antenna 22 and the lead-in wire 24 together. The connection portion 32 extends in the thickness direction of the main body 26 containing the fiber part 28.

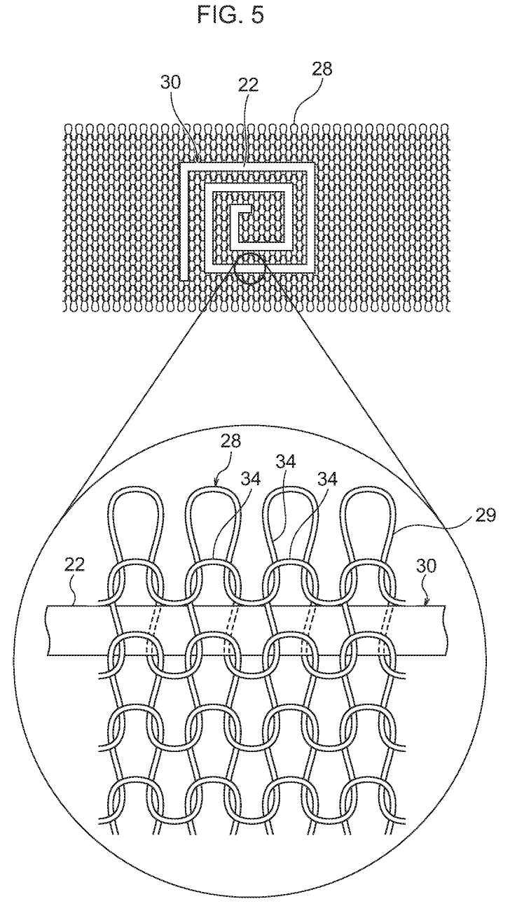

FIG. 5 illustrates the antenna 22 and the fiber part 28 in an enlarged view. A knitted article formed by knitting thread material is employed for the fiber part 28, rather than a woven article formed by interweaving weft and warp. Unlike a woven article, a knitted article has a structure with no warp thread, and is formed by hooking together plural loops 34. Moreover, the electrically conductive wire 30 including the antenna 22 and the like described above is intertwined into the fiber part 28.

The electrically conductive wire 30 including the antenna 22 and the like is a separate member to a thread material 29 forming the fiber part 28, and more specifically, is intertwined into the fiber part 28 during a knitting process of the fiber part 28 (in the same fiber part 28 knitting process), at the same time as the fiber part 28 is formed. The electrically conductive wire 30 is, for example, formed thicker than the thread material employed in the fiber part 28, and is incorporated within gaps in the pattern of the fiber part 28.

Next, explanation follows regarding a manufacturing method (assembly method) of the electronic device 10 according to the first exemplary embodiment.

First, as illustrated in FIG. 5, the thread material is knitted to form the fiber part 28, which is a knitted article. Various knitting methods may be applied for the fiber part 28. In the knitting process of the fiber part 28, the electrically conductive wire 30 including the antenna 22 and the like described above is intertwined into the fiber part 28 at the same time as the fiber part 28 is being formed.

The shape, size, and position of the antenna 22 and the lead-in wire 24 (see FIG. 4) may be freely set. Various electrically conductive wires may be applied as the electrically conductive wire 30, including bare wires and covered wires, as well as, for example, twisted wire lines or plaited wire lines including resin threads. Examples of materials of the fiber part 28 and the electrically conductive wire 30 include, for example, polyamide-covered glass fiber threads for the fiber part 28, and, for example, copper wire for the electrically conductive wire 30.

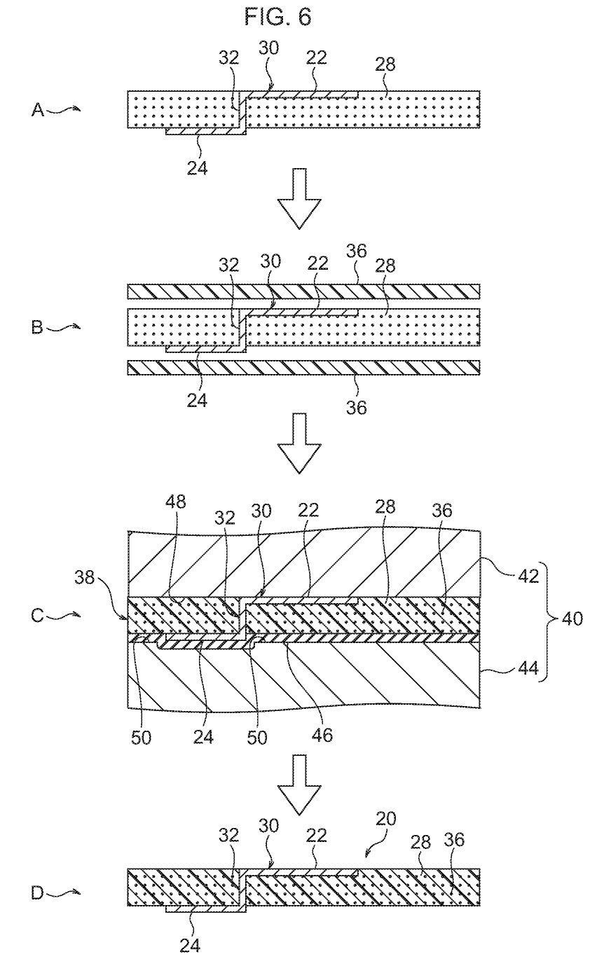

In process A, as illustrated in FIG. 6, the fiber part 28 is formed with the electrically conductive wire 30 including the antenna 22, the lead-in wire 24, and the connection portion 32 intertwined therein. Next, in process B, as illustrated in FIG. 6, the fiber part 28 is impregnated with a resin 36 from the outer side and the inner side of the fiber part 28, to form a prepreg 38 (see process C). A thermoplastic resin or a thermosetting resin is employed as the resin 36.

Next, in process C, as illustrated in FIG. 6, the prepreg 38 is set in a heated die 40, and the prepreg 38 is press molded. The die 40 includes an upper die 42 and a lower die 44, and thin, plate shaped rubber 46 is interposed between the fiber part 28 impregnated with the resin 36 and the lower die 44. A forming face 48 of the upper die 42 is formed flat and smooth, and the lower die 44 is formed with projections 50 corresponding to portions around the lead-in wire 24.

In process D, as illustrated in FIG. 6, the molded lower cover 20 is then removed from the die 40. Since the forming face 48 of the upper die 42 is formed flat and smooth, the outer face of the lower cover 20 formed by the forming face 48 is also formed flat and smooth. During press molding, the portion around the lead-in wire 24 is pressed by the projections 50, such that the lead-in wire 24 is formed protruding out from the inner face of the lower cover 20.

In the lower cover 20 formed from the prepreg 38 in this manner, the electrically conductive wire 30 including the antenna 22, and the fiber part 28, are fully integrated together with the resin 36 that serves as a resin matrix. Note that the electrically conductive wire 30 may employ a covered wire, and the covered wire may employ a thermoplastic resin as the covering material. The covering material may then be softened or melted so as to be integrated together with the resin 36 during press molding.

Next, the lower cover 20 is, for example, injection molded (insert molded) after the above press molding. Various structural components are integrated into the lower cover 20 by this injection molding. Moreover, the upper cover 18 illustrated in FIG. 1 is also formed separately to the lower cover 20, by injection molding or the like. The upper cover 18 may be formed from a fiber reinforced plastic, similarly to the main body 26 of the lower cover 20.

Components such as a display device, switches, and the like are then attached to the upper cover 18 and the lower cover 20, and the unit 14 is attached to the lower cover 20. The upper cover 18 is then attached to the lower cover 20 and the unit 14 is housed inside the case 12, thus completing the electronic device 10.

Next, explanation follows regarding operation and advantageous effects of the first exemplary embodiment.

As described in detail above, in the first exemplary embodiment, the antenna 22 is intertwined into the fiber part 28 as illustrated in FIG. 4, and is formed integrally to the lower cover 20. The forming of connection portions of plural members in the lower cover 20 is accordingly avoided, thereby enabling the strength of the lower cover 20 to be secured.

Moreover, since the lower cover 20 can be integrally formed, the number of components can be reduced in comparison to when, for example, the lower cover 20 is formed from plural members, thereby enabling a reduction in costs.

Moreover, the antenna 22 is intertwined into the fiber part 28 at the same time as the fiber part 28 is formed during the knitting process of the fiber part 28 (in the same fiber part 28 knitting process), thereby enabling the number of manufacturing processes to be reduced. This also enables a reduction in costs.

The structure in which the electrically conductive wire 30 including the antenna 22 and the like is intertwined into the fiber part 28 enables the antenna 22 to be formed on the outer side of the fiber part 28, namely, on the outer face side of the lower cover 20. This thereby enables good sensitivity of the antenna 22 to be achieved.

The structure in which the electrically conductive wire 30 including the antenna 22 and the like is intertwined into the fiber part 28 enables the electrically conductive wire 30 to run from the inner side to the outer side of the lower cover 20. This thereby renders a separate process to form the antenna 22 separately to the lead-in wire 24 unnecessary, enabling a reduction in costs.

As illustrated in FIG. 6, the antenna 22 is intertwined into the fiber part 28 prior to press molding, thereby enabling the antenna 22 to be disposed inward of an outer face of the resin 36 that is formed by press molding. This thereby enables the flatness of the outer face of the resin 36, namely the outer face of the lower cover 20, to be secured.

Moreover, as illustrated in FIG. 5, the antenna 22 is incorporated within the pattern of the fiber part 28, thereby suppressing unevenness in volume in the fiber part 28. This thereby enables concentration of stress during press molding to be suppressed, enabling the flatness of the outer face of the lower cover 20 to be further improved.

Moreover, the degrees of freedom in the layout of the antenna 22 can be improved since the electrically conductive wire 30 can be intertwined into the fiber part 28 at a freely selected location.

Moreover, as illustrated in FIG. 6, together with the fiber part 28, the electrically conductive wire 30 including the antenna 22 is integrated together with the resin 36 that serves as a resin matrix, thereby protecting the antenna 22.

Next, explanation follows regarding modified examples of the first exemplary embodiment.

In the first exemplary embodiment, the lower cover 20 may, for example, be applied to other electronic devices, such as notebook computers, as well as mobile devices such as smartphones and tablets.

Moreover, the structure including the fiber part 28 and the antenna 22 in the lower cover 20 described above may also be applied to the upper cover 18 illustrated in FIG. 1, and may be applied to members other than the casing of an electronic device.

The lower cover 20 includes the antenna 22 as an example of “wiring”. However, wiring with a function other than that of the antenna 22 may be interwoven into the fiber part 28.

The fiber part 28 is impregnated with the resin 36 that serves as a resin matrix.

However, as the resin matrix, instead of the resin 36, the fiber part 28 may employ a pre-coated resin, or the fiber part 28 may employ resin fibers interwoven into the fiber part 28 in advance.

### Second Exemplary Embodiment

Next, explanation follows regarding a second exemplary embodiment of technology disclosed herein.

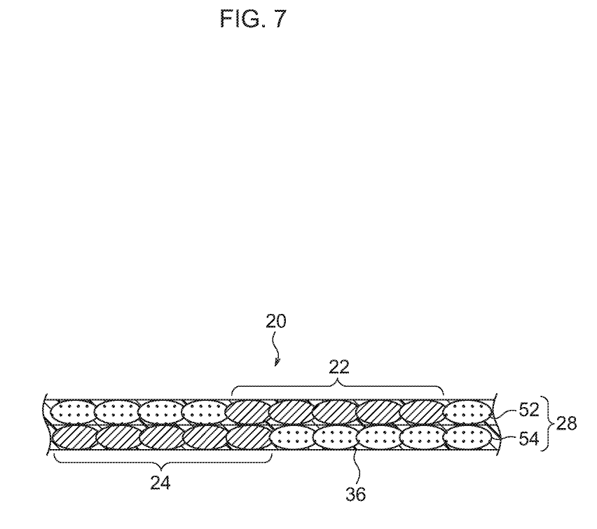

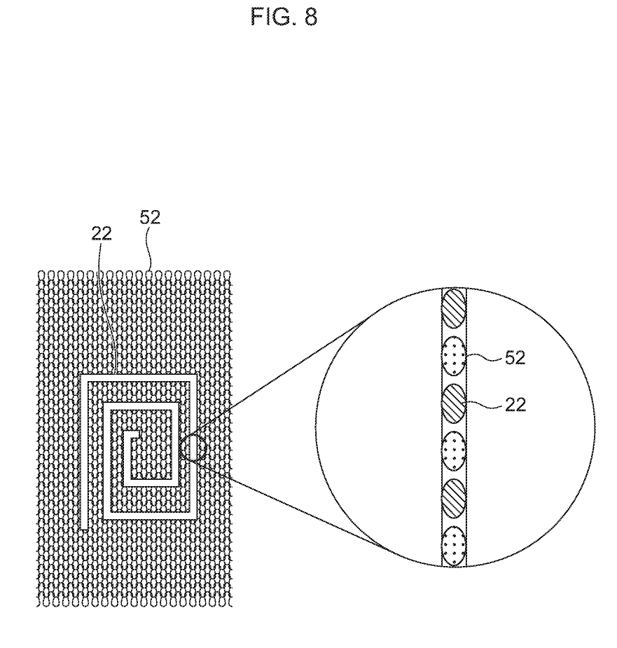

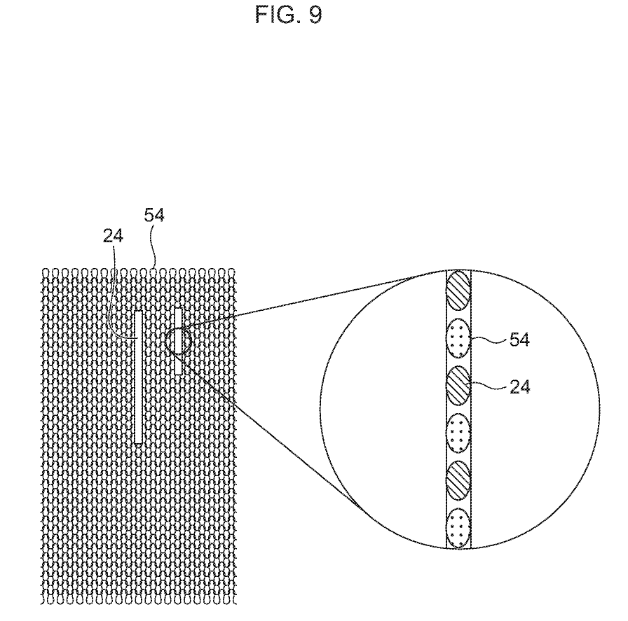

In the second exemplary embodiment, the structure of the lower cover 20 is modified from that of the first exemplary embodiment in the following manner. Namely, as illustrated in FIG. 7, the fiber part 28 includes a first layer 52 and a second layer 54, both of which are knitted articles. FIG. 8 includes a plan view and an enlarged cross-section of relevant portions of the first layer 52, and FIG. 9 includes a plan view and an enlarged cross-section of relevant portions of the second layer 54.

As illustrated in FIG. 8, the antenna 22 is interwoven into the first layer 52. As illustrated in FIG. 9, the lead-in wire 24 is interwoven into the second layer 54.

Next, explanation follows regarding a manufacturing method of the lower cover 20 according to the second exemplary embodiment.

First, as illustrated in FIG. 8 and FIG. 9, the first layer 52 including the antenna 22, and the second layer 54 including the lead-in wire 24, are formed by knitting separately to each other. Various knitting methods may be applied for the first layer 52 and second layer 54. In the knitting process of the first layer 52, the antenna 22 is interwoven into the first layer 52 at the same time as the first layer 52 is formed. Similarly, in the knitting process of the second layer 54, the lead-in wire 24 is interwoven into the second layer 54 at the same time as the second layer 54 is formed.

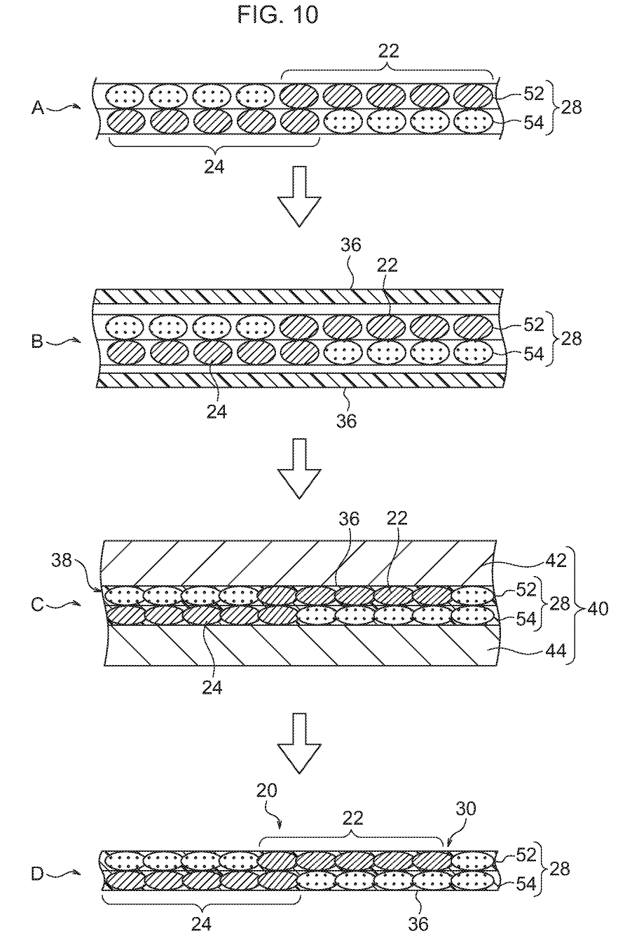

Then, as illustrated by process A in FIG. 10, the first layer 52 intertwined with the antenna 22, and the second layer 54 intertwined with the lead-in wire 24, are superimposed to form the fiber part 28. When this is performed, the first layer 52 is positioned at the outer side of the fiber part 28, and the second layer 54 is positioned at the inner side of the fiber part 28. Next, as illustrated by process B in FIG. 10, the fiber part 28 is impregnated with the resin 36 from the outer side and the inner side to form the prepreg 38 (see process C).

Next, as illustrated by process C in FIG. 10, the prepreg 38 is set in the heated die 40 including the upper die 42 and the lower die 44, and the prepreg 38 is press molded. Then, as illustrated by process D in FIG. 10, the cover 20 is removed from the die 40 as a molded product.

In the lower cover 20 formed from the prepreg 38 in this manner, the antenna 22, the lead-in wire 24, and the fiber part 28 are fully integrated together with the resin 36 that serves as a resin matrix. The lead-in wire 24 is connected to the antenna 22 by press molding in the superimposed state of the first layer 52 and the second layer 54, such that the antenna 22 and the lead-in wire 24 form the electrically conductive wire 30 running from the inner side to the outer side of the lower cover 20.

In the second exemplary embodiment, the first layer 52 intertwined with the antenna 22, and the second layer 54 intertwined with the lead-in wire 24, are superimposed and molded together, thereby enabling easy forming of the electrically conductive wire 30 running from the inner side to the outer side of the lower cover 20.

Note that in the second exemplary embodiment, bare wires may be employed for the antenna 22 and the lead-in wire 24. The respective connection portions of the antenna 22 and the lead-in wire 24 may then be connected by being integrated together in the press molding.

In the second exemplary embodiment, covered wire may be employed for the electrically conductive wire 30, and an electrically conductive resin may be employed as the covering material of the covered wire. The respective connection portions of the antenna 22 and the lead-in wire 24 may then be integrated together by softening or melting the covering material covering the connection portions by the press molding. Moreover, in such cases, copper wire coated with an electrically conductive paste as an electrically conductive adhesive may, for example, be employed as the electrically conductive wire 30.

### Third Exemplary Embodiment

Next, explanation follows regarding a third exemplary embodiment of technology disclosed herein.

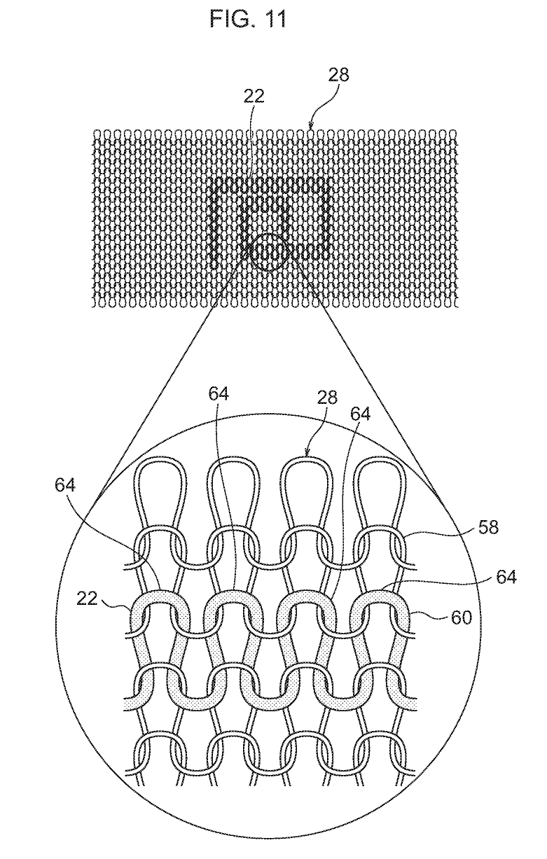

In the third exemplary embodiment, the structure of the antenna 22 is modified from that of the first exemplary embodiment described above in the following manner. Namely, as illustrated in FIG. 11, the antenna 22 employed in the third exemplary embodiment is formed from a similarly thin electrically conductive wire 60 to a thread material 58 employed in the fiber part 28.

The antenna 22 is interwoven into the fiber part 28 by substituting the thread material used to form the fiber part 28 with the electrically conductive wire 60 during the knitting process of the fiber part 28 (in the same process as the fiber part 28 knitting process). Since the antenna 22 is formed by substituting the thread material used to form the fiber part 28 with the electrically conductive wire 60, the antenna 22 forms a section of the pattern of the fiber part 28.

In the third exemplary embodiment, the antenna 22 is also formed integrally to the lower cover 20 when the antenna 22 is interwoven into the fiber part 28 by substituting the thread material used to form the fiber part 28 with the electrically conductive wire 60. The strength of the lower cover 20 can accordingly be secured since the lower cover 20 can be integrally formed without forming connection portions of plural members in the lower cover 20.

Moreover, since the antenna 22 is interwoven into the fiber part 28 by substituting the thread material used to form the fiber part 28 with the electrically conductive wire 60 in the knitting process of the fiber part 28, the number of manufacturing processes can be reduced, thereby enabling a reduction in costs.

Note that the thin electrically conductive wire 60 may be employed as-is in the antenna 22, as illustrated in FIG. 11. However, the electrically conductive wire 60 forming the antenna 22 may be processed in the following manner when press molding the prepreg including the antenna 22.

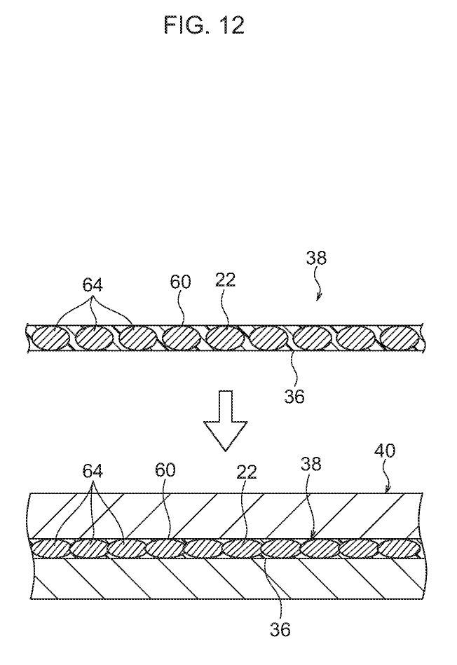

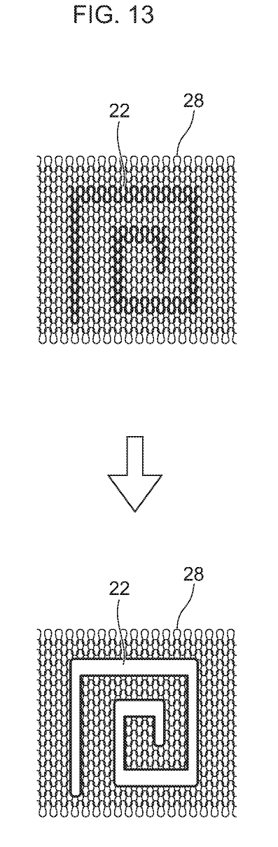

Namely, in the example illustrated in FIG. 12, when press molding the prepreg 38 including the antenna 22 in the die 40, adjacent loops 64 of the electrically conductive wire 60 (see also FIG. 11) are connected together by hardening after being melted and baked in press molding. The upper part of FIG. 13 illustrates a state of the fiber part 28 prior to press molding, and the lower part of FIG. 13 illustrates a state of the fiber part 28 after press molding.

In this manner, the adjacent loops 64 of the electrically conductive wire 60 are connected together by press molding, enabling the breadth of the antenna 22 to be increased in comparison to when the thin electrically conductive wire 60 is used as-is in the antenna 22, as illustrated in FIG. 11. This thereby enables the resistance of the antenna 22 to be decreased, enabling improved sensitivity of the antenna 22 as a result.

Note that in the third exemplary embodiment, the electrically conductive wire 60 may be either bare wire or covered wire. Moreover, in cases in which covered wire is employed for the electrically conductive wire 60, an electrically conductive resin may be employed as the covering material of the covered wire.

The adjacent loops 64 of the electrically conductive wire 60 may then be connected by integrating together by softening or melting the covering material covering the loops 64 in press molding. Moreover, in such cases, copper wire coated with an electrically conductive paste as an electrically conductive adhesive may, for example, be employed as the electrically conductive wire 60.

Moreover, in the third exemplary embodiment, the lower cover 20 includes the antenna 22 as an example of “wiring”. However, wiring with a function other than that of the antenna 22 may be interwoven into the fiber part 28.

### Fourth Exemplary Embodiment

Explanation follows regarding a fourth exemplary embodiment of technology disclosed herein.

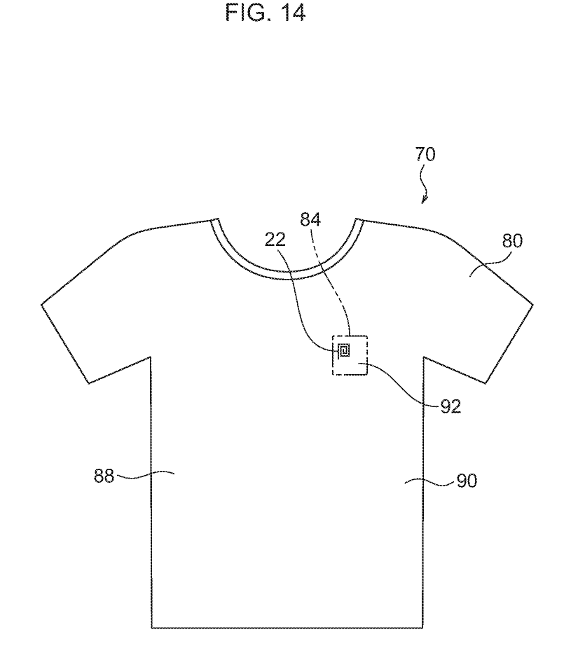

An electronic device 70 according to the fourth exemplary embodiment illustrated in FIG. 14 is a wearable device such as a T-shirt, and includes a wearable member 80 and a unit 84. The unit 84 includes an input device, a sensor, a control circuit, a battery, and the like, and is attached to the wearable member 80. The wearable member 80 is an example of a “member”, and is formed as a T-shirt.

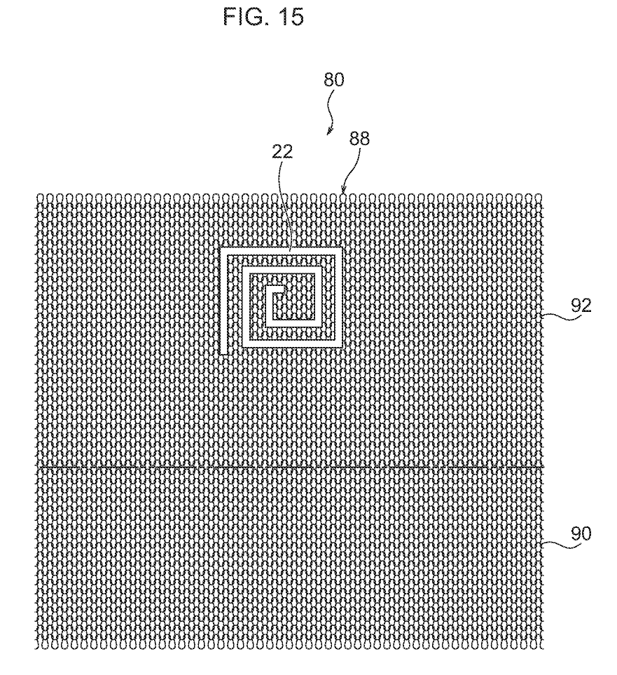

The wearable member 80 includes a fiber part 88, which is a knitted article. The fiber part 88 includes a general region 90 and a high strength region 92 (see also FIG. 15). Cotton thread, for example, is employed as the thread material of the general region 90. Various materials other than cotton thread may also be applied as the thread material of the general region 90.

The high strength region 92 is formed by changing the thread material used for the general region 90 adjacent to the high strength region 92 to a thread material with higher strength than the thread material of the general region 90. Resin-coated carbon fiber, for example, is preferably used as the thread material of the high strength region 92. Moreover, a thermoplastic resin or a thermosetting resin is used for the resin coating.

An antenna 22 is interwoven into the fiber part 88. The antenna 22 is configured as a separate member to the thread material forming the fiber part 88, similarly to in the first exemplary embodiment described above (see FIG. 5), and may be incorporated within gaps in the pattern of the fiber part 88 by knitting into the fiber part 88 during the knitting process of the fiber part 88. Moreover, the antenna 22 may be also formed as a section of the pattern of the fiber part 88 by knitting the antenna 22 into the fiber part 88 by substituting the thread material used to form the fiber part 88 in the knitting process of the fiber part 88 with an electrically conductive wire, similarly to in the third exemplary embodiment described above (see FIG. 11).

Next, explanation follows regarding operation and advantageous effects of the fourth exemplary embodiment.

According to the fourth exemplary embodiment, the antenna 22 is interwoven into the fiber part 88 formed by knitting the thread material, and is either incorporated within gaps in the pattern of the fiber part 88, or forms a section of the pattern of the fiber part 88. Unevenness in volume of the fiber part 88, and thereby the occurrence of flaws such as distortion or irregularity in the fiber part 88, can accordingly be suppressed.

The antenna 22 is interwoven into the fiber part 88 at the same time as the fiber part 88 is formed during the knitting process of the fiber part 88 (in the same fiber part 88 knitting process). This thereby enables a reduction in the number of manufacturing processes. Accordingly, a reduction in costs can be achieved.

Moreover, the degrees of freedom in the layout of the antenna 22 can be improved since the antenna 22 can be interwoven into the fiber part 88 at a freely selected location.

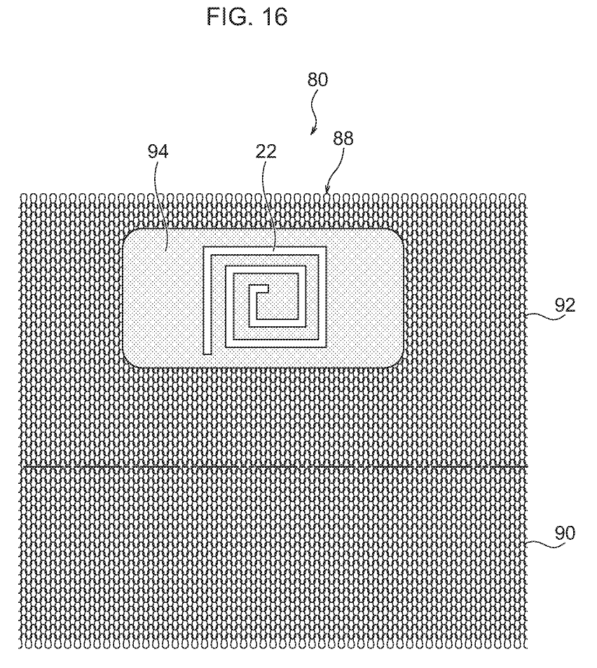

Note that in the fourth exemplary embodiment, as illustrated in FIG. 16, a support portion 94 may be formed from press molded resin in a section of the fiber part 88. As a resin matrix, the resin of the support portion 94 employs a resin impregnated into the fiber part 88, a pre-coated resin in the fiber part 88, resin fibers interwoven into the fiber part 88 in advance, or the like.

Forming the support portion 94 to a section of the fiber part 88 in this manner enables components such as the unit 84 (see FIG. 14) to be fixed to the support portion 94. Moreover, since an attachment member for fixing such components is rendered unnecessary, the number of components can be reduced, enabling a reduction in costs.

Moreover, together with a section of the fiber part 88, the antenna 22 is integrated together with the support portion 94 that serves as a resin matrix, thereby enabling the antenna 22 to be protected.

Moreover, in the fourth exemplary embodiment, the wearable member 80 may be configured in a wearable format other than a T-shirt, such as a glove, a headband, a wristband, a hat, or the like.

Moreover, the wearable member 80 includes the antenna 22 as an example of “wiring”. However, wiring with a function other than that of the antenna 22 may be interwoven into the fiber part 88.

### Fifth Exemplary Embodiment

Next, explanation follows regarding a fifth exemplary embodiment of technology disclosed herein.

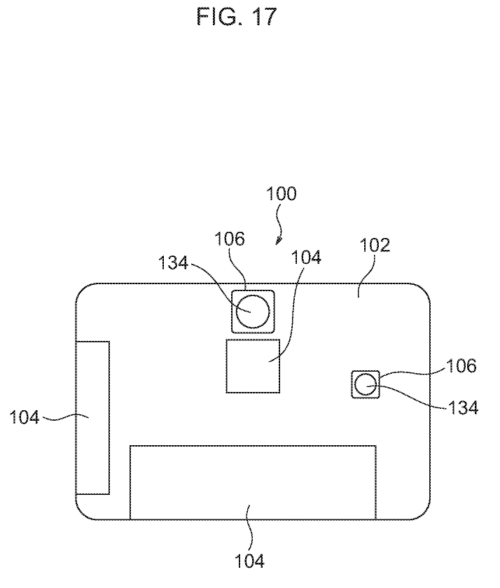

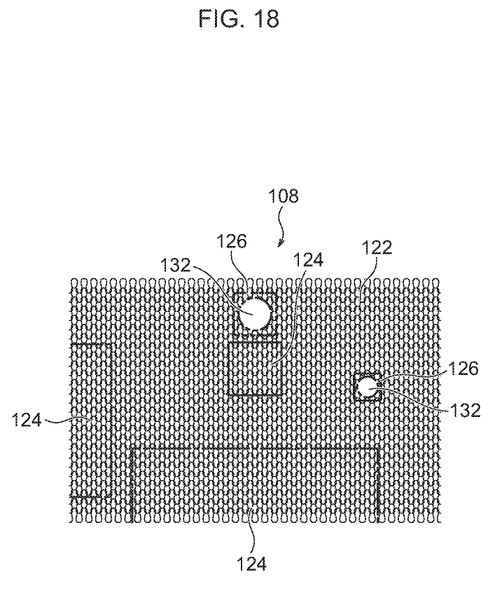

In the fifth exemplary embodiment, the structure of the lower cover is modified from that of the first exemplary embodiment described above in the following manner. Namely, as illustrated in FIG. 17, a lower cover 100 includes a high strength portion 102, radio-wave permeable portions 104, and opening-formed portions 106. The high strength portion 102, the radio-wave permeable portions 104, and the opening-formed portions 106 are integrally formed in a fiber reinforced plastic formed from a fiber part 108 (see FIG. 18), described later, and a resin 116 serving as a resin matrix. The radio-wave permeable portions 104 are disposed at positions corresponding to antennas disposed inside the lower cover 100.

As illustrated in FIG. 18, a knitted article formed by knitting thread material is employed as the fiber part 108 used in the lower cover 100, rather than a woven article formed by interweaving weft and warp. Unlike a woven article, a knitted article has a structure with no warp thread, and is formed by hooking together plural loops 34.

The fiber part 108 includes a high strength region 122, radio-wave permeable regions 124, and opening-formed regions 126. The high strength region 122, the radio-wave permeable region 124, and the opening-formed region 126 respectively form the high strength portion 102, the radio-wave permeable portion 104, and the opening-formed portion 106 (see FIG. 17) described above. Namely, the high strength portion 102, the radio-wave permeable portions 104, and the opening-formed portions 106 described above are formed by integrating the resin 116, serving as a resin matrix, with the high strength region 122, the radio-wave permeable regions 124, and the opening-formed regions 126.

The high strength region 122 is formed by changing the thread material used for the radio-wave permeable regions 124 and the opening-formed regions 126 adjacent to the high strength region 122 to a stronger thread material than that used for the radio-wave permeable region 124. Preferably, for example, carbon fibers or the like are used for the thread material of the high strength region 122.

The radio-wave permeable regions 124 are formed by changing the thread material used for the high strength region 122 adjacent to the radio-wave permeable regions 124 to a thread material that is permeable to radio waves. For example, a thread material formed from a material (with insulating properties) such as glass fibers or resin fibers that are permeable to radio waves is preferably employed as the thread material for the radio-wave permeable regions 124.

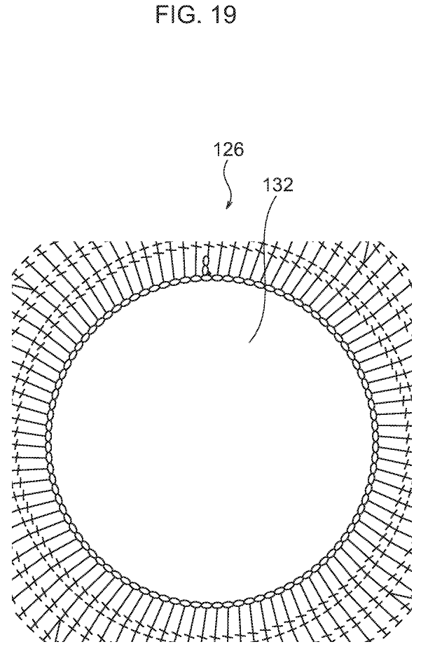

The opening-formed regions 126 are each formed with a hole 132, this being an example of an “opening” (see also FIG. 19), by changing the knitting technique at the high strength region 122 adjacent to the opening-formed region 126. For example, a resin fiber is preferably employed as the thread material for the opening-formed regions 126.

Note that the high strength region 122 is an example of an “adjacent region” to the radio-wave permeable regions 124 and the opening-formed regions 126, and the radio-wave permeable regions 124 and the opening-formed regions 126 are examples of “adjacent regions” to the high strength region 122.

Next, explanation follows regarding a manufacturing method of the lower cover 100 according to the fifth exemplary embodiment.

First, the fiber part 108, which is a knitted article, is formed, as illustrated in FIG. 18. Various knitting techniques may be applied for the fiber part 108. In this knitting process of the knitted article, the high strength region 122, the radio-wave permeable regions 124, and the opening-formed regions 126 are formed in an appropriate sequence.

The high strength region 122 is formed by changing the thread material used for the radio-wave permeable region 124 adjacent to the high strength region 122 to a stronger thread material than the thread material of the radio-wave permeable regions 124. Moreover, the radio-wave permeable regions 124 are formed by changing the thread material used for the high strength region 122 adjacent to the radio-wave permeable regions 124 to a thread material that is permeable to radio waves. Moreover, in the opening-formed regions 126, the holes 132 are formed by changing the knitting technique used for the high strength region 122 adjacent to the opening-formed regions 126 (see also FIG. 19).

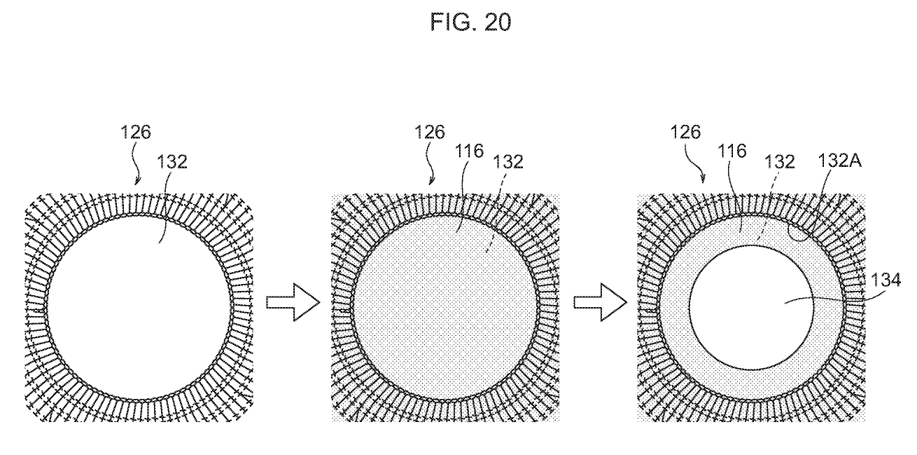

Then, similarly to in the first exemplary embodiment, the fiber part 108 is impregnated with the resin 116 to form a prepreg, and the prepreg is press molded. When this is performed, as illustrated from the left to the center of FIG. 20, in the opening-formed regions 126, the holes 132 are closed off by the resin 116, serving as a resin matrix, that has been integrated together with the opening-formed regions 126. Then, as illustrated on the right of FIG. 20, a positioning hole 134, this being an example of an “opening”, is formed in the resin 116 at the inside of an inner periphery 132A of each hole 132 in a hole opening process.

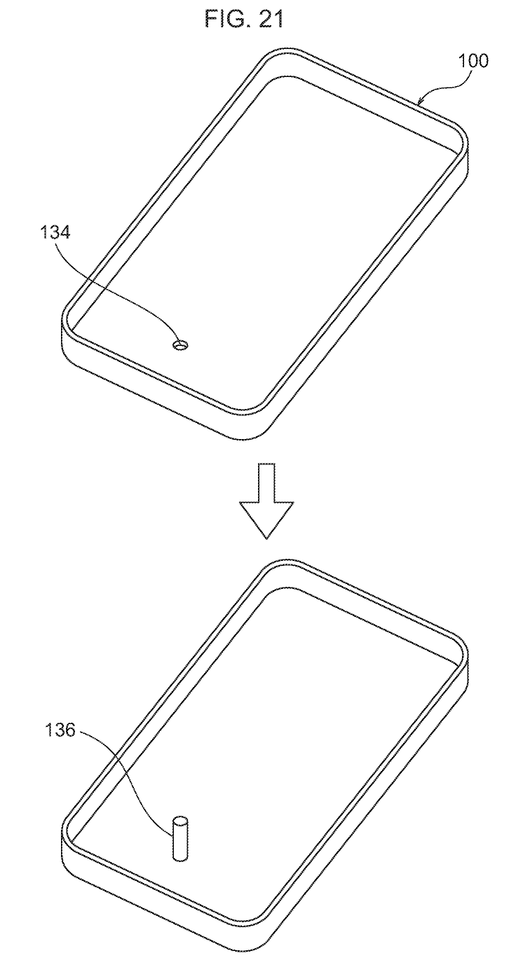

Next, as illustrated in FIG. 21, the lower cover 100 formed from the prepreg is, for example, injection molded (insert molded) after the press molding described above. During the injection molding, a guide pin 136 is inserted into the positioning hole 134 described above. Inserting the guide pin 136 into the positioning hole 134 positions the lower cover 100 with respect to a mold for injection molding.

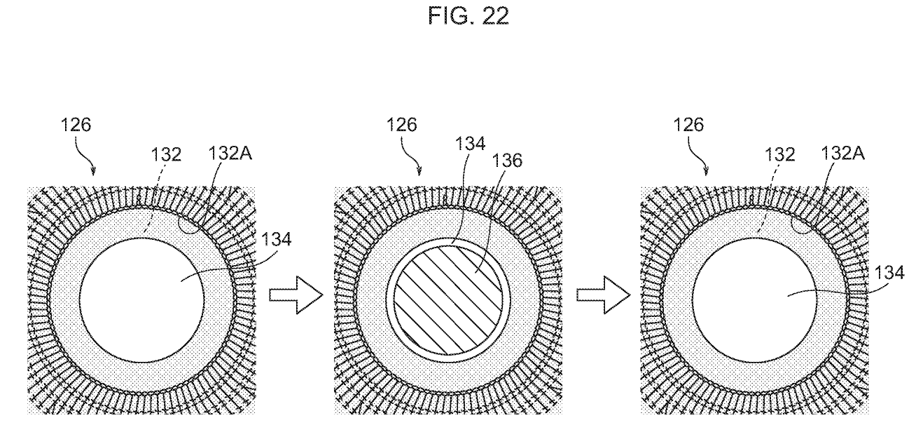

The left, center, and right parts of FIG. 22 illustrate, in sequence, a state prior to inserting the guide pin 136 into the positioning hole 134, a state in which the guide pin 136 has been inserted into the positioning hole 134, and a state in which the guide pin 136 has been pulled out from the positioning hole 134 after injection molding. The lower cover 100 illustrated in FIG. 21 is integrally formed with various structural parts during injection molding.

Next, explanation follows regarding operation and advantageous effects of the fifth exemplary embodiment.

As described in detail above, in the fifth exemplary embodiment, a knitted article formed by knitting thread material is employed as the fiber part 108 used in the lower cover 100, rather than a woven article formed by interweaving weft and warp. Accordingly, each region, such as the high strength region 122, the radio-wave permeable regions 124, and the opening-formed regions 126 can be disposed at freely selected locations according to their respective purposes. This thereby enables the degrees of freedom in the layout of the antenna and the holes 132 (positioning holes 134) to be improved, and also enables the rigidity and permeability to radio-waves of the lower cover 100 to be secured.

Moreover, the fiber part 108 is formed with the high strength region 122, the radio-wave permeable regions 124, and the opening-formed regions 126, thereby integrally forming the lower cover 100 with the high strength portion 102, the radio-wave permeable portions 104, and the opening-formed portions 106. The forming of connection portions for plural members in the lower cover 100 is accordingly avoided, thus enabling the strength of the lower cover 100 to be secured.

Since the lower cover 100 can be integrally formed including the high strength portion 102, the radio-wave permeable portions 104, and the opening-formed portions 106, the number of components can be reduced, and a reduction in costs can be achieved, in comparison to, for example, cases in which the lower cover 100 is formed from plural members.

In each opening-formed region 126 of the fiber part 108, the hole 132 is pre-formed by changing the knitting technique at a region adjacent to the opening-formed region 126 (see FIG. 19). Accordingly, there is no need to form the hole 132 in the opening-formed region 126 of the fiber part 108 by subsequent processing, thereby enabling the occurrence of burr at the inner periphery of the hole 132 to be suppressed.

Moreover, as illustrated in FIG. 20, the positioning hole 134 is formed in the resin 116 inside the inner periphery 132A of the hole 132. The inner periphery 132A of the hole 132 is thereby covered by the resin 116. Accordingly, a cover over the inner periphery 132A of the hole 132 can be achieved without being formed by subsequent processing, thereby enabling a reduction in costs.

Next, explanation follows regarding modified examples of the fifth exemplary embodiment.

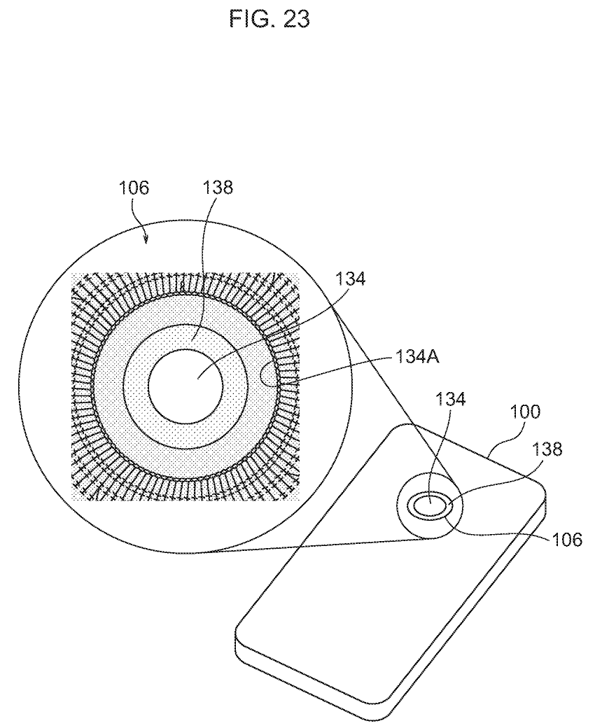

As illustrated in FIG. 23, in the fifth exemplary embodiment, a cover 138 may be additionally formed at an inner periphery 134A of the positioning hole 134 formed in the opening-formed portion 106 during injection molding.

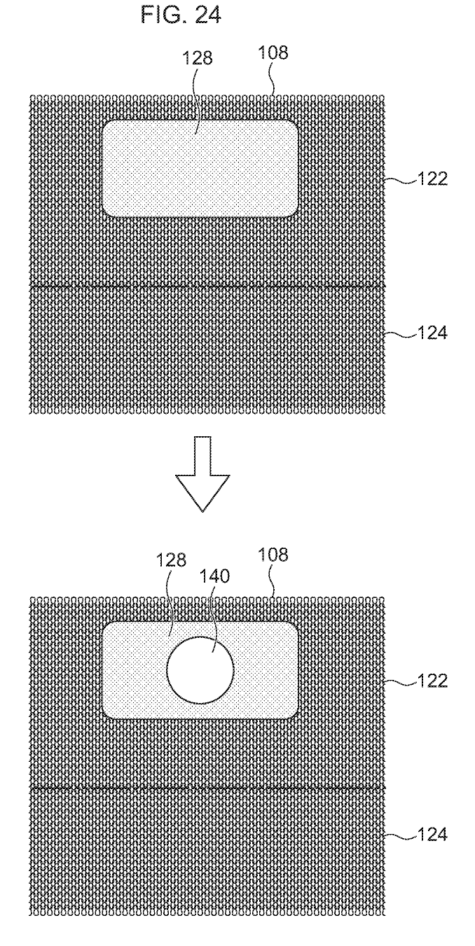

Moreover, as illustrated by the upper part of FIG. 24, in the fifth exemplary embodiment, a resin region 128 may be formed to the fiber part 108. The resin region 128 is, for example, formed by changing the thread material used for the high strength region 122 adjacent to the resin region 128 to a resin thread material. Such a resin thread material employs a polyamide, for example. The resin region 128 is press molded and cured either in a resin-impregnated state, or in an unmodified state that has not been impregnated with resin. Then, as illustrated by the lower part of FIG. 24, the cured resin region 128 is further formed with a hole 140, this being an example of an “opening”.

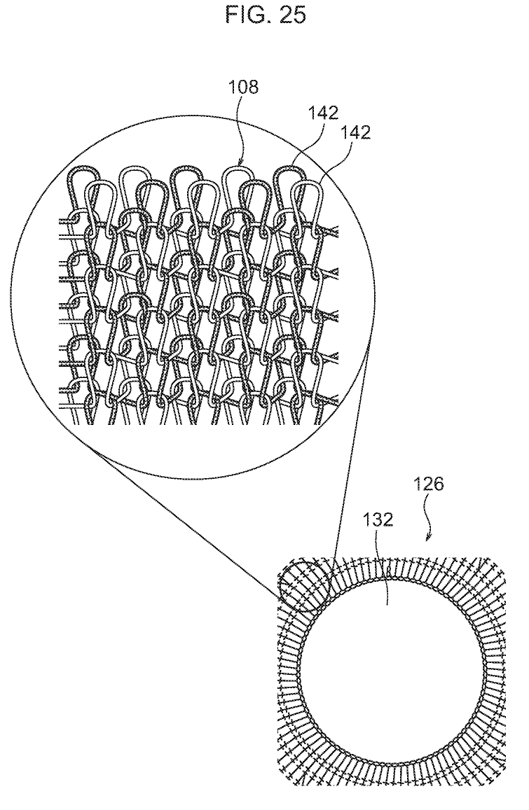

As illustrated in FIG. 25, in the fifth exemplary embodiment, the fiber part 108 may include plural layers 142 formed using multi-layer knitting. Forming the plural layers 142 using multi-layer knitting enables the thickness and strength of the fiber part 108 to be controlled.

In the example illustrated in FIG. 25, the hole 132 may be formed in the plural layers 142 of the opening-formed region 126 by a single operation. Namely, the hole 132 is included in the pattern of the plural layers 142, and is formed at the same time as the plural layers 142 are formed when knitting the plural layers 142.

When the hole 132 is formed in the plural layers 142 by a single operation in this manner, misalignment of the position of the hole 132 between the plural respective layers 142 can be suppressed. Moreover, since misalignment of the plural layers 142 with respect to each other can be suppressed, stylistic quality can also be secured.

In the fiber part 108 according to the fifth exemplary embodiment, a general region, this being an example of an “adjacent region”, and at least one out of the high strength region 122, the radio-wave permeable region 124, the opening-formed region 126, and the resin region 128, may be combined as desired. Moreover, the sequence for forming the respective regions may also be freely set.

Moreover, in the fifth exemplary embodiment, instead of the hole described above, a notch may be formed as an example of an “opening”.

Moreover, in the fifth exemplary embodiment, the fiber part 108 is impregnated with the resin 116 that serves as a resin matrix (see FIG. 20). However, instead of the resin 116, a pre-coated resin in the fiber part 108 may be employed as the resin matrix, or a resin fiber interwoven into the fiber part 108 in advance, may be employed as the resin matrix.

### Sixth Exemplary Embodiment

Next, explanation follows regarding a sixth exemplary embodiment of the technology disclosed herein.

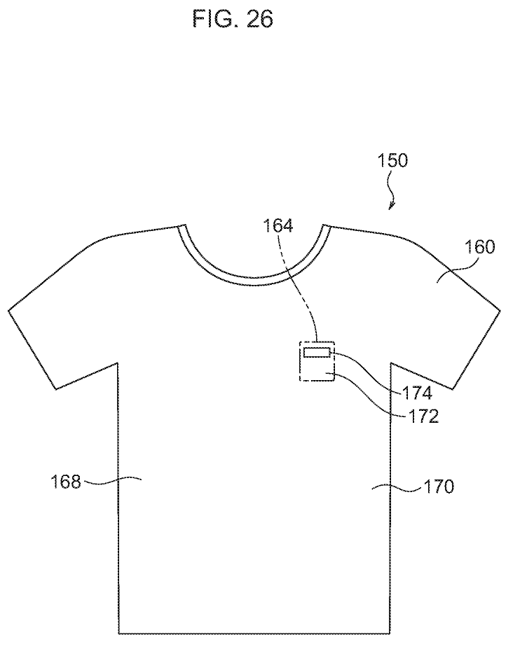

An electronic device 150 according to the sixth exemplary embodiment illustrated in FIG. 26 is a wearable device such as a T-shirt, and includes a wearable member 160 and a unit 164. The unit 164 includes an input device, a sensor, a control circuit, a battery, and the like, and is attached to the wearable member 160. The wearable member 160 is an example of a “member”, and is formed as a T-shirt

The wearable member 160 includes a fiber part 168, which is a knitted article.

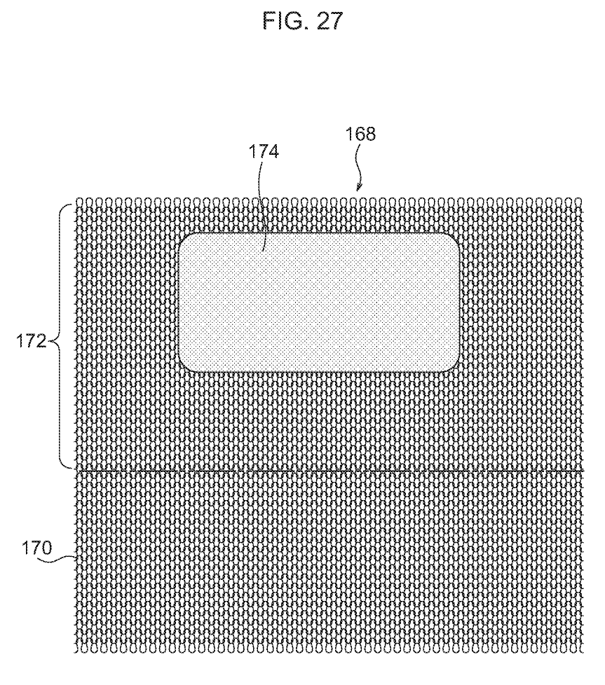

The fiber part 168 includes a general region 170 and a high strength region 172 (see also FIG. 27). Cotton thread, for example, is employed as the thread material of the general region 170. Various materials may be applied as the thread material of the general region 170.

The high strength region 172 is formed by changing the thread material used for the general region 170 adjacent to the high strength region 172 to a thread material with higher strength than the thread material of the general region 170. For example, resin-coated carbon fiber, twisted threads of carbon fiber twisted together with resin threads such as a polyamide, or knitted threads in which resin threads such as polyamide are intertwined with carbon fibers by French knitting, are preferably employed as the thread material of the high strength region 172. Moreover, a thermoplastic resin or a thermosetting resin is employed for the resin coating.

A support portion 174 is formed on a section of the high strength region 172 (see also FIG. 27) by press molding a resin. As a resin matrix, the resin of the support portion 174 employs, for example, a resin impregnated into the fiber part 168, a resin coated onto the fiber part 168 in advance, or resin fibers interwoven into the fiber part 168 in advance. The unit 164 is attached to the support portion 174.

Next, explanation follows regarding operation and advantageous effects of the sixth exemplary embodiment.

In the sixth exemplary embodiment, the fiber part 168 of the wearable member 160 is formed from a knitted article. The general region 170 and the high strength region 172 can be integrally formed in the fiber part 168, thereby enabling a reduction in costs.

Moreover, the support portion 174 is formed in the high strength region 172, and components such as the unit 164 can be fixed to the support portion 174. An attachment member to attach such components is thereby rendered unnecessary, enabling a reduction in the number of components, and enabling a reduction in costs.

The support portion 174 for attaching the unit 164 is formed in the high strength region 172, enabling rigidity around the support portion 174 to be secured. Accordingly, positional displacement of the support portion 174 can be suppressed even in a state in which the unit 164 is attached to the support portion 174.

The support portion 174 and the high strength region 172 are formed integrally to the fiber part 168, thereby enabling a sense of cohesion when the wearable member 160 is being worn, as well as enabling an improvement in the ease of design.

Note that in the sixth exemplary embodiment, the wearable member 160 may be configured in a wearable format other than a T-shirt, such as a glove, a headband, a wristband, a hat, or the like.

Moreover, the fiber part 168 of the wearable member 160 may include at least one out of a high strength region, a radio-wave permeable region, an opening-formed region, or a resin region, similarly to the fiber part 108 of the lower cover 20 of the fifth exemplary embodiment described above (see FIG. 18). Moreover, the sequence for forming the respective regions may be freely set.

Moreover, the fiber part 168 of the wearable member 160 may include plural layers 142 (see FIG. 25) formed using multi-layer knitting, similarly to in the fifth exemplary embodiment described above.

Moreover, combinable exemplary embodiments out of the first to the sixth exemplary embodiments described above may be implemented in appropriate combinations with each other.

Explanation has been given regarding the first to the sixth exemplary embodiments of technology disclosed herein. However, technology disclosed herein is not limited to the above, and obviously various modifications may be implemented within a range not departing from the spirit of the technology disclosed herein.

All cited documents, patent applications, and technical standards mentioned in the present specification are incorporated by reference in the present specification to the same extent as if the individual cited documents, patent applications, or technical standards were specifically and individually incorporated by reference in the present specification.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A member comprising:
a fiber part, which is a knitted article; and
wiring intertwined into the fiber part.

2. The member of claim 1, wherein the wiring is a separate member to a thread material forming the fiber part, and is intertwined into the fiber part during a knitting process of the fiber part.

3. The member of claim 1, wherein wiring is intertwined into the fiber part by substituting a thread material employed to form the fiber part with an electrically conductive wire during a knitting process of the fiber part.

4. The member of claim 3, wherein adjacent loops of the electrically conductive wire are connected together by press molding.

5. The member of claim 1, wherein at least a portion of the fiber part around the wiring and the wiring are integrated together with a resin.

6. The member of claim 1, wherein:
the wiring is an antenna; and
the antenna is formed on an outer side of the fiber part.

7. The member of claim 6, wherein:
the fiber part includes a first layer positioned on the outer side of the fiber part and intertwined with the antenna, and a second layer positioned on an inner side of the fiber part and intertwined with a lead-in wire; and
the lead-in wire is connected to the antenna in a superimposed state of the first layer and the second layer.

8. An electronic device comprising:
the member of claim 1; and
a unit attached to the member.

9. A manufacturing method for a member of claim 1, the manufacturing method comprising:
forming a fiber part by knitting; and
intertwining wiring into the fiber part.

10. An electronic device manufacturing method comprising:
attaching a unit to the member manufactured using the member manufacturing method of claim 9.

11. A member comprising a fiber part includes at least one out of:
a high strength region formed by changing a thread material employed for a knitted adjacent region to a thread material stronger than the thread material used in the adjacent region;
a radio-wave permeable region formed by changing a thread material employed for a knitted adjacent region to a thread material that is permeable to radio waves;
an opening-formed region formed with an opening by changing a knitting technique used in a knitted adjacent region; or a resin region formed by changing a thread material employed for a knitted adjacent region to a resin and press molding, and by further forming an opening.

12. The member of claim 11, wherein:
the fiber part includes the opening-formed region;
at least the opening-formed region of the fiber part is integrated with a resin; and
an opening is formed in the resin further inside than a periphery of the opening.

13. The member of claim 11, wherein the fiber part includes a plurality of layers formed using multi-layer knitting.

14. The member of claim 13, wherein:
the fiber part includes the opening-formed region; and
the opening is formed in the opening-formed region to the plurality of layers in a single operation.

15. The member of claim 11, wherein:
the fiber part includes the high strength region; and
the high strength region is formed with a support portion using a press molded resin.

16. An electronic device comprising:
the member of claim 11; and
a unit attached to the member.

17. A manufacturing method for a member of claim 1, the manufacturing method comprising forming a fiber part including at least one out of:
a high strength region formed by changing a thread material employed for a knitted adjacent region to a thread material stronger than the thread material used in the adjacent region;
a radio-wave permeable region formed by changing a thread material employed for a knitted adjacent region to a thread material that is permeable to radio waves;
an opening-formed region formed with an opening by changing a knitting technique used in a knitted adjacent region; or
a resin region formed by changing a thread material employed for a knitted adjacent region to a resin and press molding, and by further forming an opening.

18. An electronic device manufacturing method comprising attaching a unit to the member manufactured using the member manufacturing method of claim 17.

19. The electronic device of claim 8, wherein the member is a cover that forms a case.

20. The electronic device of claim 8, wherein the member is a wearable member.
